(19) United States
(12) Patent Application Publication
(10) Pub. No.: US 2022/0219644 A1
(43) Pub. Date: Jul. 14, 2022

(54) GESTURE RECOGNITION SYSTEM FOR A VEHICLE

(71) Applicant: GM GLOBAL TECHNOLOGY OPERATIONS LLC, Detroit, MI (US)

(72) Inventors: Wei Tong, Troy, MI (US); Shuqing Zeng, Sterling Heights, MI (US); Xiaofeng F. Song, Novi, MI (US); Mohannad Murad, Troy, MI (US); Upali P. Mudalige, Oakland Township, MI (US)

(21) Appl. No.: 17/145,615

(22) Filed: Jan. 11, 2021

(51) Int. Cl. B60R 25/30; G06F 3/01; B60R 25/24; B60R 25/01; B60R 25/31

(52) U.S. Cl. CPC B60R 25/305; G06F 3/017; B60R 25/24; B60R 25/2054; B60R 25/31; B60R 2325/205; B60R 25/01

(57) ABSTRACT

A vehicle includes a body supporting at least one camera. The at least one camera is positioned to collect images of objects outside of the vehicle. The vehicle also includes a selectively operable vehicle system and a controller operatively connected to the at least one camera and the selectively operable vehicle system. The controller includes a gesture recognition system operable to process a gesture made by a person associated with the vehicle collected by the at least one camera and activate the selectively operable vehicle system associated with the gesture.

### INTRODUCTION

The subject disclosure relates to the art of motor vehicles and, more particularly, to a gesture recognition system for a vehicle.

Many vehicles include systems that respond to a driver's presence. For example, a vehicle may detect a key fob and turn on interior and/or exterior lights. A vehicle may respond to a driver's touch and the key fob by unlocking a door or a trunk. A vehicle may also include a sensor mounted to detect a foot movement. In response, a trunk may be unlocked and opened. While effective and convenient for opening a trunk without the need to use a key, the system requires a dedicated sensor mounted under the vehicle. The use of a dedicated sensor adds cost and complexity. Further, there is a need for additional structure to protect and shield the sensor. Accordingly, the industry would welcome a system that adds convenience to the operation of a vehicle without the need for additional dedicated sensors.

### SUMMARY

In one exemplary embodiment, a vehicle includes a body supporting at least one camera. The at least one camera is positioned to collect images of objects outside of the vehicle. The vehicle also includes a selectively operable vehicle system and a controller operatively connected to the at least one camera and the selectively operable vehicle system. The controller includes a gesture recognition system operable to process a gesture made by a person associated with the vehicle collected by the at least one camera and activate the selectively operable vehicle system associated with the gesture.

In addition to one or more of the features described above or below, or as an alternative, further embodiments could include wherein the at least one camera comprises a back-up camera.

In addition to one or more of the features described above or below, or as an alternative, further embodiments could include a sensor mounted in the vehicle and operatively connected to the controller, the sensor being operable to detect the person associated with the vehicle approaching the body and activate the at least one camera.

In addition to one or more of the features described above or below, or as an alternative, further embodiments could include wherein the sensor comprises a key fob sensor operable to detect a key fob associated with the vehicle.

In addition to one or more of the features described above or below, or as an alternative, further embodiments could include wherein the sensor comprises a cell phone sensor operable to detect a cell phone associated with the person associated with the vehicle.

In addition to one or more of the features described above or below, or as an alternative, further embodiments could include wherein the at least one camera includes an exterior camera and an interior camera, the controller being operable to process the gesture made by the person associated with the vehicle collected by one of the exterior camera and the interior camera and activate the selectively operable vehicle system associated with the gesture.

In addition to one or more of the features described above or below, or as an alternative, further embodiments could include wherein the controller includes a memory module having stored thereon one or more factory pre-set gestures, the one or more factory pre-set gestures being associated with activating the select vehicle system.

In addition to one or more of the features described above or below, or as an alternative, further embodiments could include wherein the controller includes a gesture learning module, the gesture learning module being operable to learn a gesture associated with activating the select vehicle system.

In addition to one or more of the features described above or below, or as an alternative, further embodiments could include wherein the select vehicle system includes a trunk lid latch.

In addition to one or more of the features described above or below, or as an alternative, further embodiments could include wherein the controller is operatively connected to at least one vehicle light, the controller being configured to activate the at least one vehicle light if ambient light conditions are below a preselected level.

In another exemplary aspect, a method of activating a vehicle system includes detecting a person associated with the vehicle, capturing a gesture by the operator with a camera mounted to the vehicle, and activating the vehicle system based on the gesture.

In addition to one or more of the features described above or below, or as an alternative, further embodiments could include wherein capturing the gesture with the camera includes capturing an image of the person associated with the vehicle with a back-up camera.

In addition to one or more of the features described above or below, or as an alternative, further embodiments could include wherein detecting the person associated with the vehicle includes activating the camera.

In addition to one or more of the features described above or below, or as an alternative, further embodiments could include wherein detecting the person associated with the vehicle includes sensing one of a key fob associated with the vehicle and a cell phone associated with the person associated with the vehicle.

In addition to one or more of the features described above or below, or as an alternative, further embodiments could include wherein capturing the gesture includes capturing a movement of the person associated with the vehicle external to the vehicle.

In addition to one or more of the features described above or below, or as an alternative, further embodiments could include processing the gesture, comparing the gesture to one or more factory pre-set gestures, and activating the vehicle system associated with the factory pre-set gesture.

In addition to one or more of the features described above or below, or as an alternative, further embodiments could include wherein processing the gesture includes determining whether predetermined constraint conditions are met including evaluating one of a skeletal structure position, a skeletal structure orientation, and a skeletal structure height.

In addition to one or more of the features described above or below, or as an alternative, further embodiments could include receiving a user defined gesture, and activating the vehicle system upon perceiving the user defined gesture through the camera.

In addition to one or more of the features described above or below, or as an alternative, further embodiments could include wherein activating the vehicle system includes operating a trunk lid latch.

In addition to one or more of the features described above or below, or as an alternative, further embodiments could include activating a vehicle light to illuminate the gesture when ambient light conditions are below a preselected level.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 depicts a vehicle having a gesture recognition system, in accordance with an exemplary embodiment;

FIG. 2 depicts a vehicle system controller including a gesture recognition system, in accordance with an exemplary aspect; and

FIG. 3 depicts a flow chart showing a method for activating a vehicle system based on gesture recognition, in accordance with an exemplary aspect.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

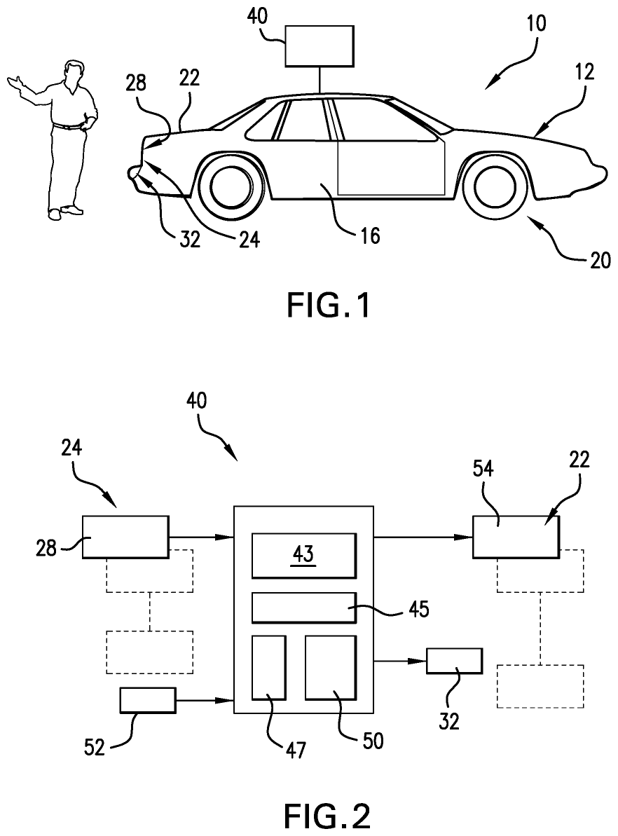

A vehicle, in accordance with an exemplary embodiment, is indicated generally at 10 in FIG. 1. Vehicle 10 shown in the form of a passenger car 12 that includes a body 16 that may be supported by a chassis (not shown) and is provided with a plurality of wheels indicated generally at 20. Vehicle 10 may take on a variety of forms including electric vehicles, hybrid vehicles, vehicles powered by internal combustion engines, including gas and diesel powered engines, trucks, vans, SUV's and the like. Passenger car 12 is shown to include a trunk 22, a camera 24 that is shown in the form of a rear view of back-up camera 28 and a rear light 32.

In accordance with an exemplary embodiment, vehicle 10 includes a gesture recognition system 40 which, as will be detailed herein, can perceive a gesture from a person associated with vehicle 10, process the gesture, and selectively operate a vehicle system such as to unlatch trunk 22. It should be understood that a person associated with the vehicle means a person that has been previously identified as, for example, an owner, a lessor or other individual associated with the vehicle by virtue of possession of a vehicle key or by associating a cell phone with the vehicle.

Referring to FIG. 2, gesture recognition system 40 includes a controller 43 and a non-volatile memory 45 that may store a set of instructions for operating controller 43. Gesture recognition system 40 further includes a gesture recognition module 47. In addition to instructions, non-volatile memory 45 may also store factory pre-set gestures as well as actions associated with each gesture. Each gesture or group of gestures may be perceived, evaluated, and used to trigger a response such as to unlatch trunk 22 as well as other actions such as activating a vehicle ignition, additional cameras and the like. Gesture recognition system 40 may also include a gesture learning module 50 that allows a user to set up user defined gestures and associated actions. At this point, it should be understood that while shown as being part of a single component, gesture recognition system 40 may be distributed through various components in vehicle 10.

In an embodiment, gesture recognition system 40 is operatively coupled to camera 24 and a sensor 52 that may detect a presence of a person associated with vehicle 10. At this point, it should be understood, that camera 24 may represent back-up camera 28 and/or additional cameras mounted externally to and/or internally to vehicle 10. Camera 24 may include front mounted cameras, cameras mounted in side view mirrors, dash mounted cameras and the like. Sensor 52 may also take on a variety of forms including a key fob detecting sensor, a cell phone detecting sensor, as well as other sensors that may detect a person associated with vehicle 10. Gesture recognition system 40 may also be selectively coupled to a cell phone or other input device (not shown) that may facilitate uploading user defined gestures, system updates and the like.

In further accordance with an exemplary aspect, gesture recognition system 40 may also be coupled to trunk 22 and, more specifically, to a trunk latch 54 associated with locking and unlocking trunk 22. Gesture recognition system 40 may also be connected to one or more additional vehicle systems such as an ignition system, a car seat adjustment system, a steering wheel adjustment system, door lock system, and the like. Still further, gesture recognition system 40 may be coupled to light 32. That is, in the event gesture recognition module 47 determines that there is insufficient ambient light to process a captured gesture, gesture recognition system 40 may activate light 32.

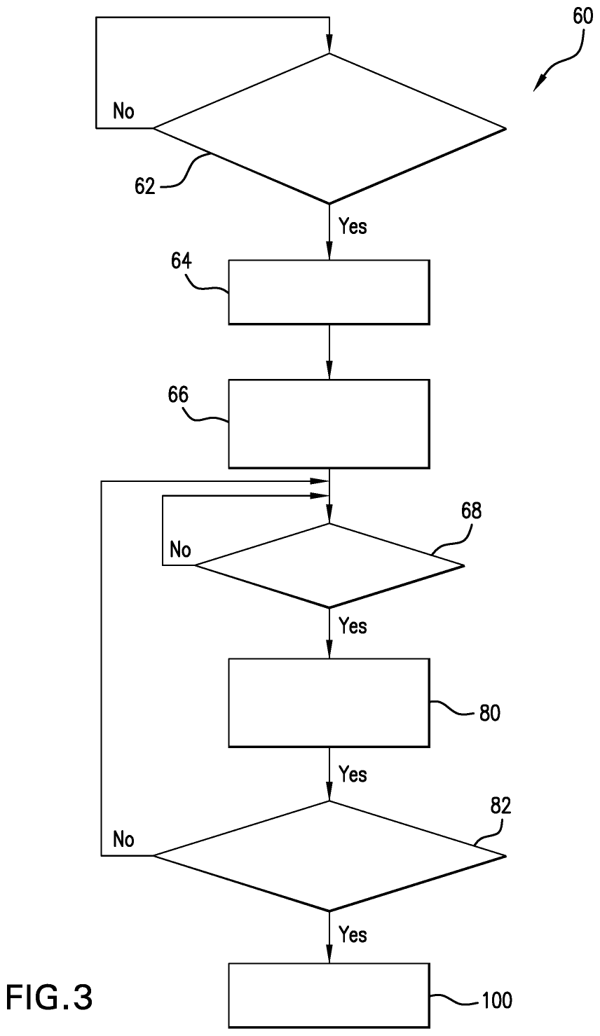

Reference will now follow to FIG. 3, with continued reference to FIG. 2, in describing a method 60 of capturing gestures and activating a vehicle system in accordance with an exemplary aspect. In block 62, gesture recognition system 40 detects that an activation condition is met. For example, gesture recognition system can sense that a person associated with the vehicle is approaching by detecting a key fob, a cell phone or the like. In block 64 back-up camera 28 is activated. If so equipped, additional cameras mounted about vehicle 10 may also be activated. In block 66, light 32 may be activated if ambient light conditions are below a predetermined level.

In block 68, gesture recognition system 40 determines whether a skeletal structure of the person associated with vehicle 10 is detected. Detection of the skeletal structure facilitates capturing and evaluating gestures made by the person associated with vehicle 10. If a skeletal structure is detected, gesture recognition system 40 determines whether a gesture is made that corresponds to a gesture stored in memory 45 in block 80. If no gesture is detected, gesture recognition system 40 continues monitoring until, for example, the person associated with vehicle 10 enters a passenger compartment (not separately labeled).

If a gesture is detected, in block 82 a determination is made whether certain constraint conditions are met. For example, gesture recognition system 40 may evaluate skeletal structure position, skeletal structure orientation, and/or skeletal structure height to determine whether the captured gesture matches one stored in memory 45. If the constraint conditions are met, in block 100, gesture recognition system 40 activates the corresponding vehicle system. For example, gesture recognition system 40 may activate truck latch 54 allowing trunk 22 to open. If the constraint conditions are not met, gesture recognition system 40 continues monitoring until, for example, the person associated with vehicle 10 enters a passenger compartment (not separately labeled).

At this point, it should be understood that the gesture recognition system in accordance with exemplary embodiments allows a person associated with a vehicle to activate a vehicle system without the need for a special or dedicated sensor. Further, the gesture recognition system expands options available to a person associated with the vehicle. That it, the person is not limited to simply opening a trunk, but can rely on preset gestures and/or program various user defined gestures to activate any number of vehicle systems.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

1. A vehicle comprising:
a body supporting at least one camera, the at least one camera being positioned to collect images of objects outside of the vehicle;
a selectively operable vehicle system; and
a controller operatively connected to the at least one camera and the selectively operable vehicle system, the controller including a gesture recognition system operable to process a gesture made by a person associated with the vehicle collected by the at least one camera and activate the selectively operable vehicle system associated with the gesture, wherein the controller is operable to download user defined gestures from a cell phone.

2. The vehicle according to claim 1, wherein the at least one camera comprises a back-up camera.

3. The vehicle according to claim 1, further comprising: a sensor mounted in the vehicle and operatively connected to the controller, the sensor being operable to detect the person associated with the vehicle approaching the body and activate the at least one camera.

4. The vehicle according to claim 3, wherein the sensor comprises a key fob sensor operable to detect a key fob associated with the vehicle.

5. The vehicle according to claim 3, wherein the sensor comprises a cell phone sensor operable to detect a cell phone associated with a the person associated with the vehicle.

6. The vehicle according to claim 1, wherein the at least one camera includes an exterior camera and an interior camera, the controller being operable to process the gesture made by the person associated with the vehicle collected by one of the exterior camera and the interior camera and activate the selectively operable vehicle system associated with the gesture.

7. The vehicle according to claim 1, wherein the controller includes a memory module having stored thereon one or more factory pre-set gestures, the one or more factory pre-set gestures being associated with activating the select vehicle system.

8. (canceled)

9. The vehicle according to claim 1, wherein the select vehicle system includes a trunk lid latch.

10. The vehicle according to claim 1, wherein the controller is operatively connected to at least one vehicle light, the controller being configured to activate the at least one vehicle light to illuminate the user defined gesture if ambient light conditions are below a preselected level.

11. A method of activating a vehicle system comprising:
downloading a user defined gesture from a cell phone;
detecting a person associated with the vehicle;
capturing the user defined gesture by the person associated with the vehicle with a camera mounted to the vehicle; and
activating the vehicle system based on the user defined gesture.

12. The method of claim 11, wherein capturing the user defined gesture with the camera includes capturing an image of the person associated with the vehicle with a back-up camera.

13. The method of claim 11, wherein detecting the person associated with the vehicle includes activating the camera.

14. The method of claim 13, wherein detecting the person associated with the vehicle includes sensing a cell phone associated with the person associated with the vehicle.

15. The method of claim 11, wherein capturing the user defined gesture includes capturing a movement of the person associated with the vehicle external to the vehicle.

16. (canceled)

17. The method of claim 11, wherein processing the user defined gesture includes determining whether predetermined constraint conditions are met including evaluating one of a skeletal structure position, a skeletal structure orientation, and a skeletal structure height.

18. (canceled)

19. The method of claim 11, wherein activating the vehicle system includes operating a trunk lid latch.

20. The method of claim 11, further comprising: activating a vehicle light to illuminate the user defined gesture when ambient light conditions are below a preselected level.

21. The vehicle according to claim 1, wherein the controller includes a gesture learning module, the gesture learning module being operable to learn a gesture associated with activating the select vehicle system.
